(19) United States
(12) Patent Application Publication
(10) Pub. No.: US 2004/0091633 A1
(43) Pub. Date: May 13, 2004

(54) Corona-flamer ion treatment method and apparatus

(75) Inventors: John W. Wilson II, Deerfield Beach, FL (US); Robert H. Schenk, Lake Worth, FL (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: SPDI, Inc., Deerfield Beach, FL

(21) Appl. No.: 10/699,911

(22) Filed: Nov. 3, 2003

Related U.S. Application Data
(60) Provisional application No. 60/423,154, filed on Nov. 1, 2002.

(51) Int. Cl. C08J 7/18; B23K 9/00

(52) U.S. Cl. 427/532; 219/121.36

(57) ABSTRACT

A process and apparatus for substantially enhancing surface-bonding properties of a substrate simultaneously. The process includes depositing combustion ions upon the substrate substantially immediately upon generation of the combustion ions; and depositing corona ions upon the substrate substantially immediately upon generation of the corona ions. The present invention is advantageously cylindrical and other three-dimensional substrates.

### CROSS-REFERENCE TO RELATED APPLICATIONS

This non-provisional application is a continuation-in-part of the provisional patent application serial No. 60/423,154 with inventors and entitled “CORONA-FLAMER ION TREATMENT METHOD AND APPARATUS” filed Nov. 1, 2002, which is hereby incorporated by reference in its entirety.

### FIELD OF THE INVENTION

The invention is related to the field of ion treatment of substrates for enhancing surface bonding properties.

### BACKGROUND OF THE INVENTION

Ions are widely used for the treatment of organic and inorganic surfaces to promote adhesion between various materials. For example, polymer substrates that have chemically inert surfaces with low surface energies do not allow good bonding with coatings and adhesives. Thus, these surfaces need to be treated in some way to make them receptive to bonding with other substrates, coatings, adhesives and printing inks.

Corona treatment improves the surface energy of materials and is widely used in particular for treating substrates such as plastic films, foils, papers, etc. Corona treatment improves adhesion with other materials by increasing the surface energy of the substrate. A corona discharge is established between two electrodes by applying a high voltage to one of the electrodes while the other is connected to ground at typical frequencies between 10-50 kHz. Corona treatment has the advantage of working well with new manufactured substrates. However, recycled substrates may contain significant impurities or irregularities that may interfere with the ion treatment of the substrate.

Flame treatment is also extensively used in the industry for improving the surface energy of materials, most advantageously recycled plastics. In flame treatment, a surface of the substrate in exposed to a flame generated by a gas such as propane, natural gas or other combustible substance. The flame treatment not only burns off impurities in the substrate but also treats the surface with ions that promote adhesion with other materials by increasing the surface energy of the substrate.

Plasma treatment infuses the treatment zone with an inert gas that is partially ionized by the energized electrodes. While plasma treatment may provide enhanced adhesion in certain applications, a special inert gas or gas mixture and a complex control mechanism are required to realize plasma treatment. This increases the cost, complexity and maintenance of the manufacturing equipment used to process the substrates. Thus, it is desirable avoid the plasma treatment process where possible.

Empirical evaluations show that substrates, which perform well to flame treatments, tend to perform less optimally with corona treatments and substrates that perform well with corona treatments tend not to perform less optimally with flame treatment. Nevertheless a manufacture will process various substrates depending upon customer requirements. Thus, what is needed is manufacturing equipment that readily adaptable to the desired substrates.

Most ion treatment technology is adapted to treatment using a web process, where the substrate is essentially a long continuous two-dimensional sheet and ion treatment occurs using stationary rollers with a continuously moving web substrate. This has the advantage in that various processes upon the web may be located so as to limit interference between the processes. However, three dimensional non-web substrates also benefit from ion treatment to enhance surface adhesion. Such three dimensional substrates include cylindrical substrates such as cups formed from new or recycled materials. Such substrates are typically mounted upon a mandrel. A machine for processing the substrate typically has a mandrel ring having a multiplicity of evenly spaced mandrels. The ring rotates the mandrels from station to station, pausing to perform desired processes, including ion treatment. Thus, the location of the various processes to the substrate is determined by the geometry of the mandrel ring and the location of the mandrels. The rotating mandrel ring further introduces new problems in the corona process because each mandrel acts as an electrode in the corona generation process. Thus, one corona electrode is fixed and the other electrode moves from position to position in a substantially compact space. Thus, what is needed are enhancements to the ion implantation process adapted to processing cylindrical and other three-dimensional substrates.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be apparent from the following detailed description taken in conjunction with the accompanying drawings.

FIG. 1 shows a three-dimensional substrate-processing machine that has a ring with a multiplicity of mandrels.

FIG. 2 shows a detail of the contact point 202 between the print drum 204 and the mandrel with substrate attached at the PRINT station 106.

FIG. 3 shows a photograph of one embodiment of the present invention.

FIG. 4 is an illustration of the station that provides both flame and corona ion treatment to a three dimensional substrate mounted upon a mandrel ring wherein an air knife provides a curtain of air to insulate the coronal and flame heads.

FIG. 5A shows a detail of the corona head 508 and electrode 510 with an air jet 512 for restraining the corona ions.

FIG. 5B shows an alternative corona head 550 having orifices 552, 554 in substantial proximity with both the leading and trailing edge of the corona electrode 556.

FIG. 6 and FIG. 7 show views of a combination corona and flame head which produces both flame and corona ions combined, or just flame or just corona ions as desired by the application treatment of substrates.

FIG. 8 shows a perspective view of the combination corona-flamer head.

FIG. 9 shows a top view of the combination corona-flamer head 900 positioned relative to a mandrel and attached substrate or cup 902.

FIG. 10 shows a view looking head on at the corona electrode and flame slot and two orifices of FIG. 9, as would be seen from the perspective of the substrate being treated.

FIG. 11 and FIG. 12 show details of the flame head 1100 without a corona electrode.

FIG. 13 shows a detail of the perforations 1300 used for the gas or other combustible substance for generating a flame.

FIG. 14 shows a view of a dual head ion treatment at the PRETREAT station 1402 of the mandrel ring 1404.

FIG. 15 shows a single ion treatment head at a single PRETREAT station 1502.

FIG. 16 shows dual position pretreatment.

FIGS. 17-19 shows an alternate embodiment of a chiller control unit in a remote location.

### DETAILED DESCRIPTION OF THE INVENTION

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

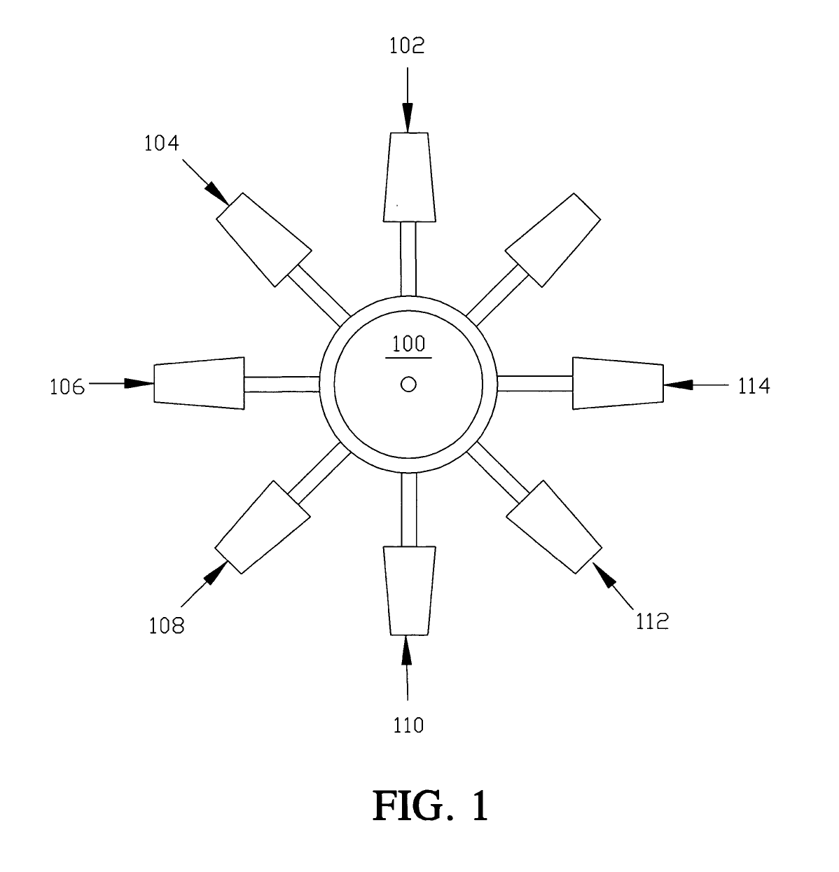

FIG. 1 shows a three-dimensional substrate-processing machine that has a ring with a multiplicity of mandrels. A three dimensional substrate, such as a plastic cup is placed on a mandrel ring at a LOAD station 102. The ring then rotates and the mandrel is moved to a PRETREAT station 104. At the PRETREAT station; the substrate is treated with ions. During the ion treatment process the mandrel and the attached substrate rotate on the axis of the mandrel. The ring then rotates again moving the mandrel and attached cup to a PRINT station 106. At the PRINT station printing is applied to the substrate preferably using offset printing techniques. During the printing process the mandrel and the attached substrate rotate. The ring then rotates again through an UNUSED station 108,and the mandrel and attached cup move to a CURE station 110, where the substrate is preferably exposed to ultraviolet light. During the curing process the mandrel and the attached substrate rotate. The ring then rotates again and the substrate is moved to a REJECT station 112, where if an imperfection in the cup, such as a pinhole, is detected in a prior process then the substrate is removed from the mandrel and processed as a rejected substrate. The ring then rotates again and the mandrel with a good substrate is rotated to the GOOD station 114, and the cup substrate is removed from the mandrel and subsequently processed as a good substrate.

Preferably, the mandrel ring 100 has eight mandrels and the processing machine thus has eight potential stations for processing three-dimensional substrates. Six stations have been described: LOAD 102, PRETREAT 104, PRINT 106, UNUSED 108,CURE 110, REJECT 112, GOOD 114 and unused. In this embodiment two of the stations are unused and may be placed at desirable locations.

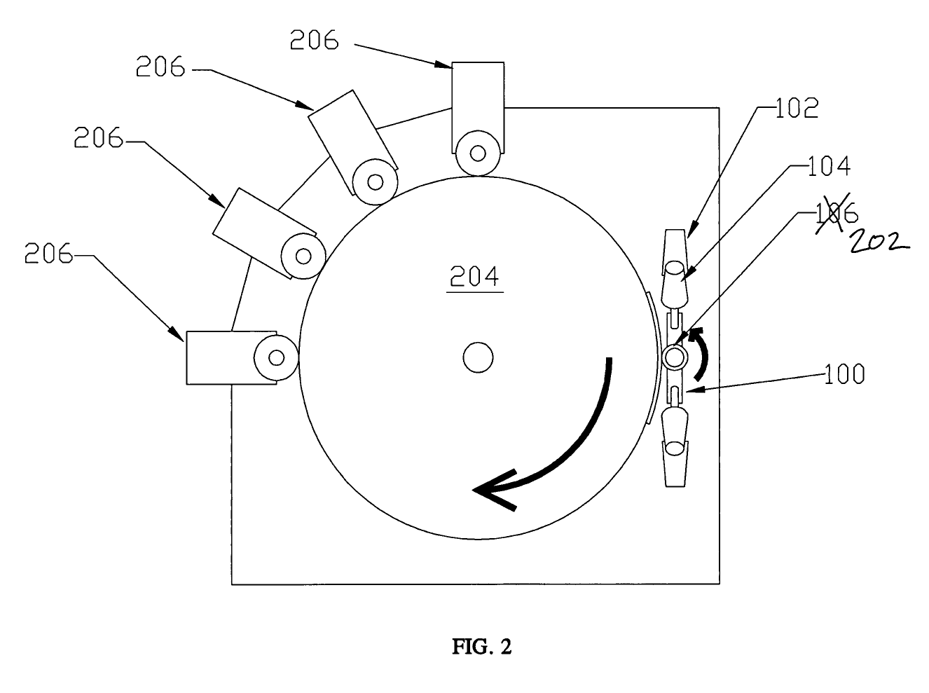

FIG. 2 shows a detail of the contact point 202 between the print drum 204 and the mandrel with substrate attached at the PRINT station 106. Note the close proximity between the large print drum 204 and the PRETREAT station 104.

In one embodiment of the invention a single PRETREAT station provides both flame and corona ion treatment. In another embodiment, there are two pretreated stations: PRETREAT 1 and PRETREAT 2. In this embodiment flame ion treatment occurs at one of the pretreatment stations and corona ion treatment occurs at the other of the pretreatment stations. Either flame or corona treating could occur first with the other treatment occurring second.

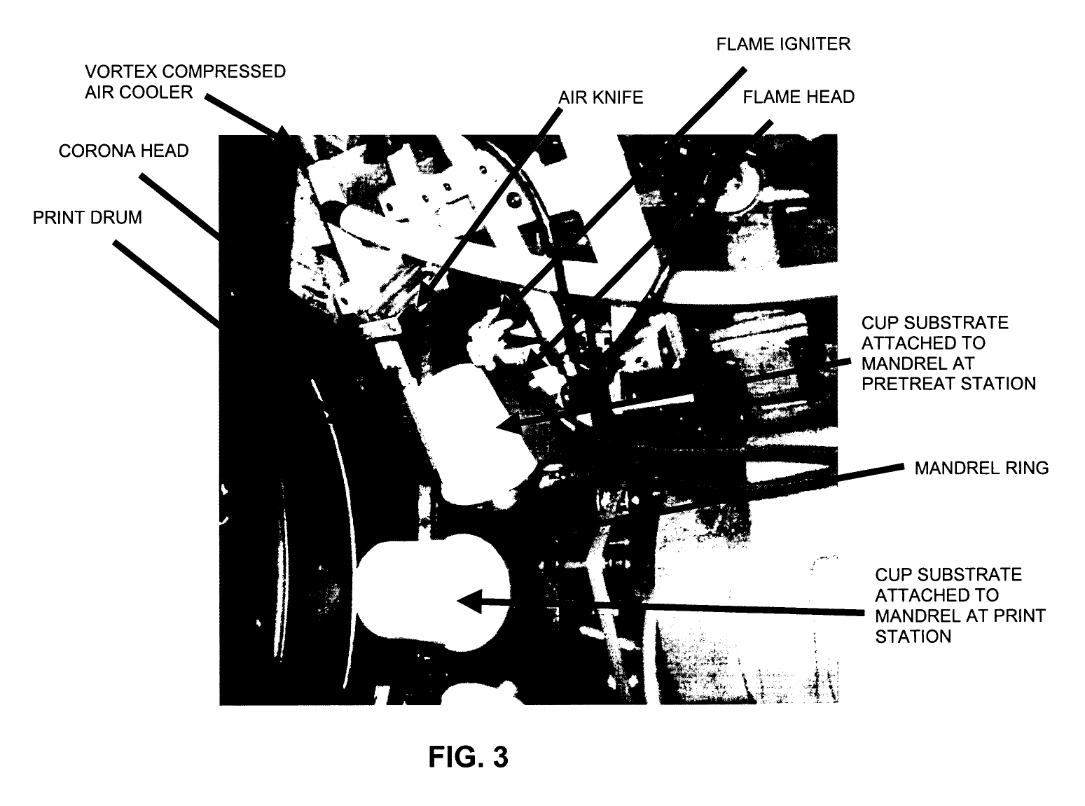

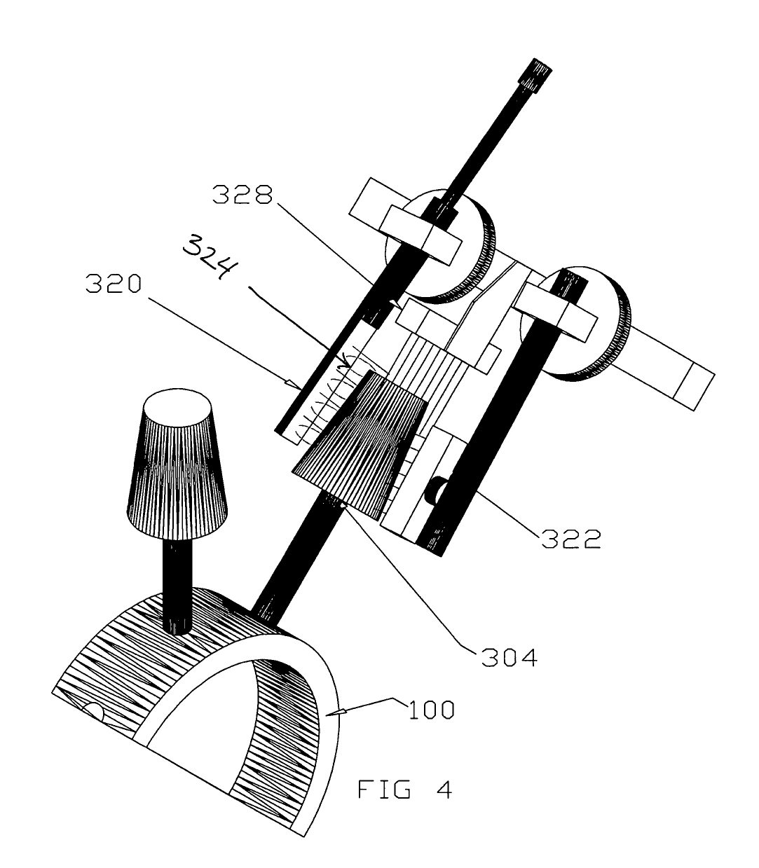

FIG. 3 shows a photograph of one embodiment of the present invention. FIG. 4 is an illustration of components of FIG. 3. The flame and the corona treating occur at a single PRETREAT station 304. It should be appreciated that the station can be set up for either flame treatment alone, corona treatment alone or simultaneous corona and flame treatment. At the PRETREAT station a cup is shown attached to a mandrel. On one side of the cup is a flame head 320 and on the other side of the cup is a corona head 322. The flame head is fed with a combustible gas that produces a flame for treating the substrate with flame ions. A separate flame igniter 328 ignites the flame.

On the opposite side of the mandrel is the corona head 322, for treating the substrate with corona ions. The corona head establishes a high voltage AC field, which establishes a corona field between the corona electrode and the mandrel, which is grounded. The frequency of the AC field is preferably 9.6 kHz using a 1.5 kW of power supply operating at 40% capacity. This setting as empirically shown to provide a satisfactory volumetric energy density for facilitating enhanced surface adhesion at reduced power settings. While the industry typically accepts a frequency range of 10 kHz or substantially higher, it has been discovered that in the three dimensional substrate applications that frequencies lower than 10 kHz are advantageous. Competing power supplies typically operate well above 10 kHz at 2 kW and 90% capacity. Thus, a preferred implementation requires a smaller power supply relative to the competition and operates at a reduced capacity because the frequency is advantageously adjusted below 10 kHz.

The corona field generates heat, and an orifice incorporated within the coronal head provides cooling. The orifice is coupled to a compressed air supply, which is cooled by a Vortex 326 compressed air chiller prior to being coupled to the orifice. Several orifice topographies are anticipated as will be set forth in more detail below. An air jet is released from the orifice. The air jet has several advantageous functions. First, the air jet feeds the corona field enhancing the ion treatment process. Second the air jet cools the substrate. Overheated substrates may unacceptably deform causing rejection of the substrate; cooling helps control the unacceptable deformation of the substrate. Third, the air jet focuses at least a portion of the corona field. It should be noted in the photograph of FIG. 3 that the corona head 322 is in close proximity with the print drum 204. The corona head produces a high voltage field, which may short or arc to the print drum due to the close proximity between the print drum and the corona head. This may not only damage the drum, but also reduce the effectiveness of the corona ion treatment process. The cup substrate turns on the axis of the attached mandrel pulling the corona field around the facilitating arching to the print drum. Preferably substantially one turn or 390 degrees of rotation of the substrate are performed during corona ion treatment. In other embodiments a multitude of turns may be used. The air jet integral to the corona head 322 helps focus the corona ions within a predefined area, thus reducing the likelihood of arching to the print drum 204 or other surrounding components.

It should be further noted that the flame head 320 is located across from the corona head 322. In the three dimensional mandrel ring application, the heads are located in this fashion to facilitate rotation of mandrels and attached substrates. Note that prior art two dimensional web treatment processes do not have the problem of mandrels which move in and out of the range of the ion treatment heads. In three-dimensional applications, stationary heads may not be placed in locations that interfere with the movement of the mandrels, and moving the heads out of the way of the moving mandrels and restoring the heads to the process position tends to result in alignment and spacing problems. Thus, fixed heads are desirable. Furthermore, some substrates may be cups shorter than the length of the flame head. In which case flames produced by the flame head could reach directly across to the electrode of the corona head. Thus, an ion path is produced between the flame and corona heads. Since the flame head is preferably electrically grounded, an undesirable arc can form between the corona and flame heads. FIG. 4 shows an air knife 324 located above the substrate at the PRETREAT station which provides an air curtain that insulates the corona head from the flame head, thereby resolving the aforementioned arcing problem. FIG. 4 is an illustration of the station that provides both flame and corona ion treatment to a three dimensional substrate mounted upon a mandrel ring wherein an air knife provides a curtain of air to insulate the coronal and flame heads. Note further that the air curtain may be further used to cool the substrate. Note further that the curtain of air has the advantage of providing insulation between the flame and corona heads without impeding rotation of the mandrels on their axis and movement of the mandrels by the rotation of the mandrel ring.

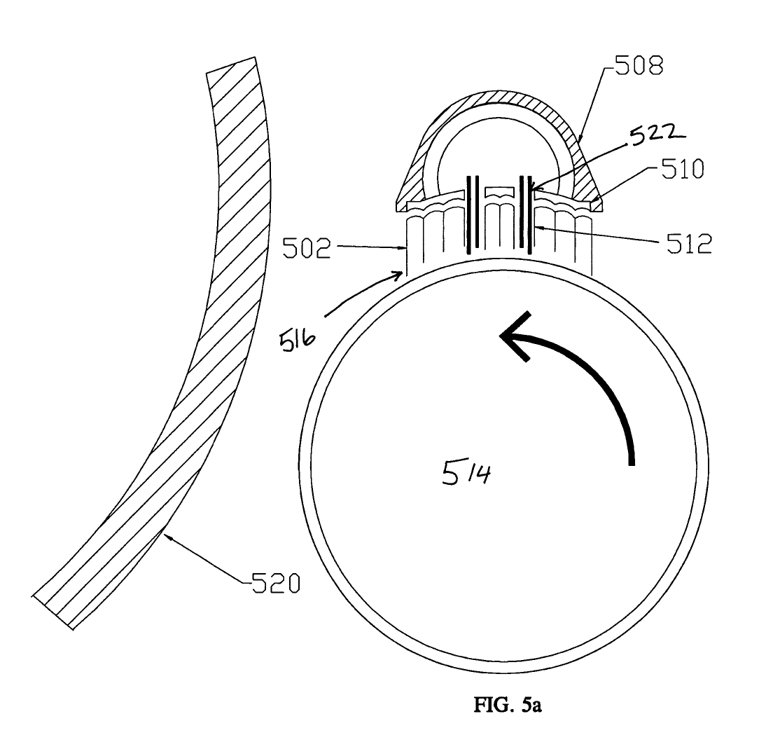

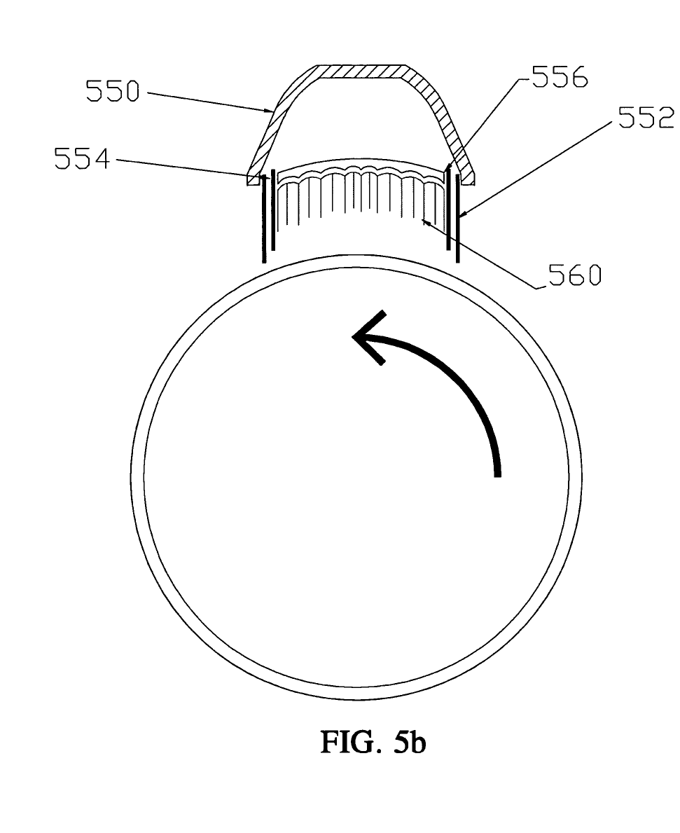

FIG. 5A shows a detail of the corona head 508 and electrode 510 with an air jet 512 for restraining the corona ions. The corona head of FIG. 5 may be used in the application of FIG. 1 to FIG. 4, or other applications. As the substrate and mandrel 514 rotate on the mandrel axis, the corona ions 502 produced by the electrode 510 of the corona field tend to be drawn beyond the trailing edge 516 of the corona electrode and further around the substrate. The print drum (or other component) 520 is in close proximity and the ions could produce a conductive path between the corona electrode and the print drum, resulting in undesirable arcing. However, an orifice 522 located is in substantial proximity with the trailing edge of the corona electrode and produces an air jet 512 substantially close to the trailing edge of the corona electrode. This air jet not only enhances the ion field and cools the substrate, but also retards the ion field, which would otherwise be result substantially beyond the trailing edge of the electrode. Retarding the corona ion field reduces the likelihood of an undesirable arc forming between the corona electrode and adjacent components, such as the print drum. Furthermore, the compressed air is optionally cooled. The cooling is preferably done by a piece of equipment known by those familiar with the art as a chiller or vortex. The vortex device is connected to the corona head providing for chilling of the air at a location close to the corona electrode. This further facilitates the advantages provided by the air jet.

FIG. 5B shows an alternative corona head 550 having orifices 552, 554 in substantial proximity with both the leading and trailing edge of the corona electrode 556. An orifice in substantial proximity means an area beyond the respective leading or trailing edge of the corona electrode, as well as an area between the center of the corona electrode and the corresponding leading or trailing edge, that facilitates substantial focusing of the corona ions 560 within an area using jets escaping from the orifices. Note that while air is the preferred embodiment, the invention is not limited to air; other gases producing a similar result are also anticipated.

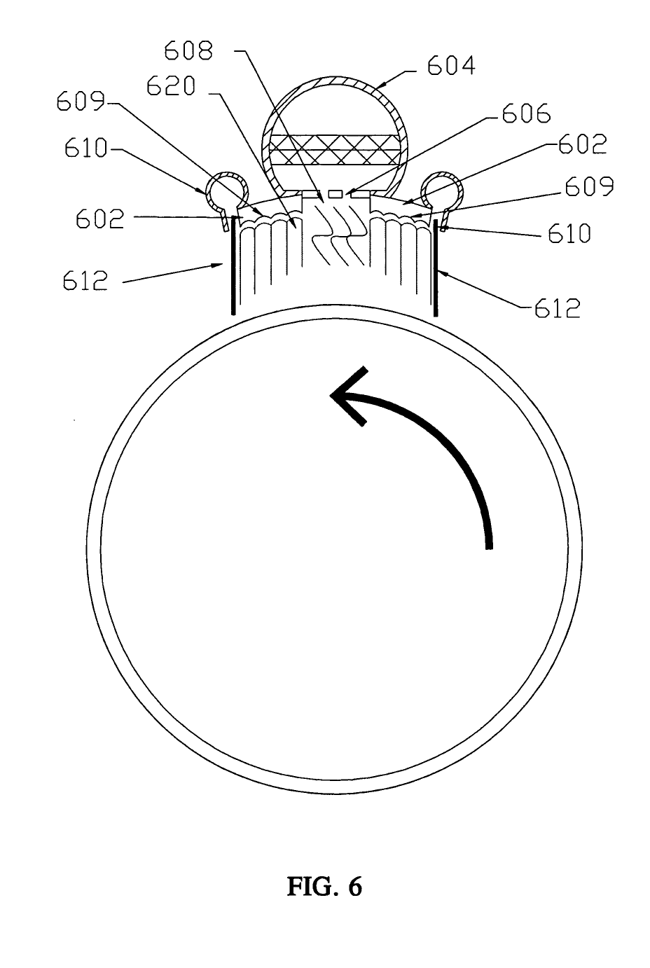

FIG. 6 and FIG. 7 show views of a combination corona and flame head which produces both flame and corona ions combined, or just flame or just corona ions as desired by the application treatment of substrates. The configuration may be controlled by simply adjusting the electrical and gas inputs to the combined head without physically replacing components. The combination head has a corona electrode 602 that has perforations for allowing gas to enter the same area as the corona ions. In this embodiment gas travels down the center of the support 604 for fixing the combined head to the processing machinery, and the perforations 606 are located in a channel 608 in the middle of the corona electrode 602. In alternate embodiments, the combustible gas could be delivered by or means such as tubing external to the combined head. Furthermore, the perforations could be in any location or other means may be used for allowing for the combination of combustible gas with the corona ions. The corona electrode also has groves 609 or is etched to enhance generation of corona ions. In substantial proximity with either edge of the corona electrode are orifices 610 of providing air jets 612 for focusing the ion field and for cooling the substrate and enhancing generation of the ions. The orifices are optional, and various embodiments may have no orifice of creating an air jet, or an orifice on the leading or trailing edge, or orifices on both the leading and trailing edges.

The combination head of FIG. 6 and FIG. 7 has the further advantage that a separate flame igniter is not required. The corona field 620 generated by the corona electrode is sufficient to ignite the combustible gas. This has the advantage of eliminating the igniter component for the flame while maintaining the ignition function. Furthermore, the prior art igniter component includes significant metallic components, which interfere with generation of the corona ions by being susceptible to arcing from the corona electrode. Not shown is a flame detector, which shuts OFF the gas supply in the absence of a flame and in the absence of a corona. In alternate embodiments, the flame may be reduced or extinguished (by switching the gas supply) during rotation of the mandrel ring and the flame re-established (by again switching the gas supply) when another mandrel is located at the PRETREAT station and the corona established. The established corona will ignite the gas without the need of a flame igniter. Switching the flame during mandrel rotation has the advantage of reducing waste heat built up with the machinery and reduces gas consumption.

The invention describes corona heads, flame heads and combination heads. It should be appreciated that these heads may be placed in various stations and station locations without departing from the scope of the invention. In one embodiment there is a single combination head at the PRETREAT station. In another embodiment there may be a second head at the PRETREAT station, such as the two head configuration demonstrated in FIG. 3 and FIG. 4. The second head may be either a combination head, a corona head or a flame head. If the second head is a corona head then the trailing air jet may be desirable on the second head. The air curtain may be also used. If there are PRETREAT 1 and PRETREAT 2 stations, then the aforementioned combinations may be utilized at either or both stations.

It should be further noted that the corona electrodes shown in the Figures preferably have a curved surface corresponding to the curve of the mandrel. This has advantages over prior art electrodes, which are substantially flat because the curved electrode provides a constant gap area between the mandrel and the electrode. This provides for more uniform treatment of the substrate with corona ions. Furthermore, the uniform gap may facilitate reduction in the amount of electrical power consumed to treat the substrate with corona ions. The invention has the further advantage in that the dimensions of the curved electrode surface still facilitates rotation of the mandrel through the PRETREAT station while allowing the corona generating head to remain stationary.

It should be further appreciated that holes in the substrate may be detected with the corona field in that arcing between the corona head and mandrel will result. This results in a power surge, which may be detected and alerted by circuitry associated with the corona power supply. The alert may be used to reject substrates at the REJECT station.

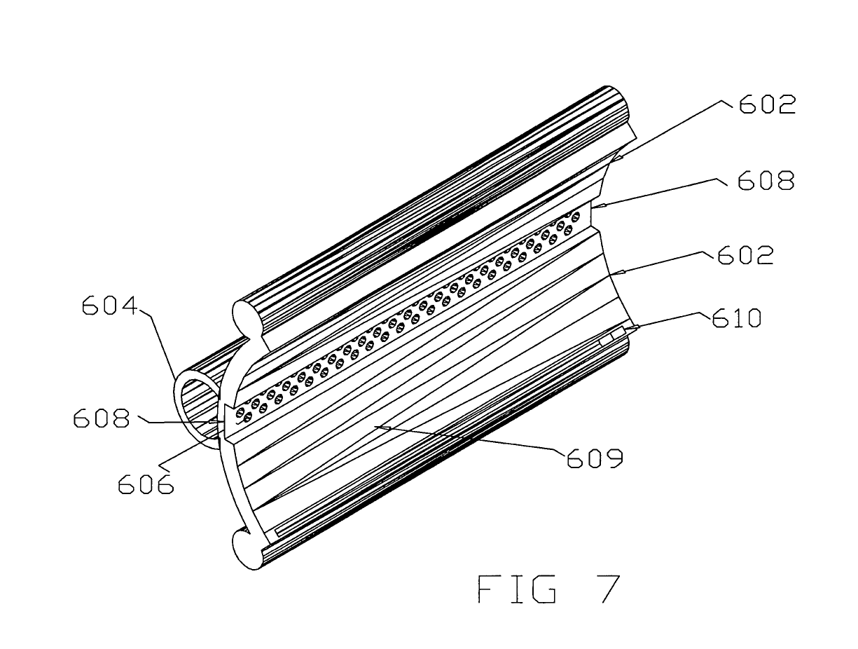

FIG. 8 shows a perspective view of the combination corona-flamer head. As in FIG. 6 and FIG. 7, the combination head has a corona electrode 802 that has perforations 804 for allowing gas to enter the same area as the corona ions. In this embodiment gas travels down the center of the support 810 for fixing the combined head to the processing machinery, and the perforations are located in a channel 812 or flame slot in the middle of the corona electrode. Ridges in the corona electrode are optional and are not shown in FIG. 8. Also, optional air jet orifices are not present in the combination head of FIG. 8.

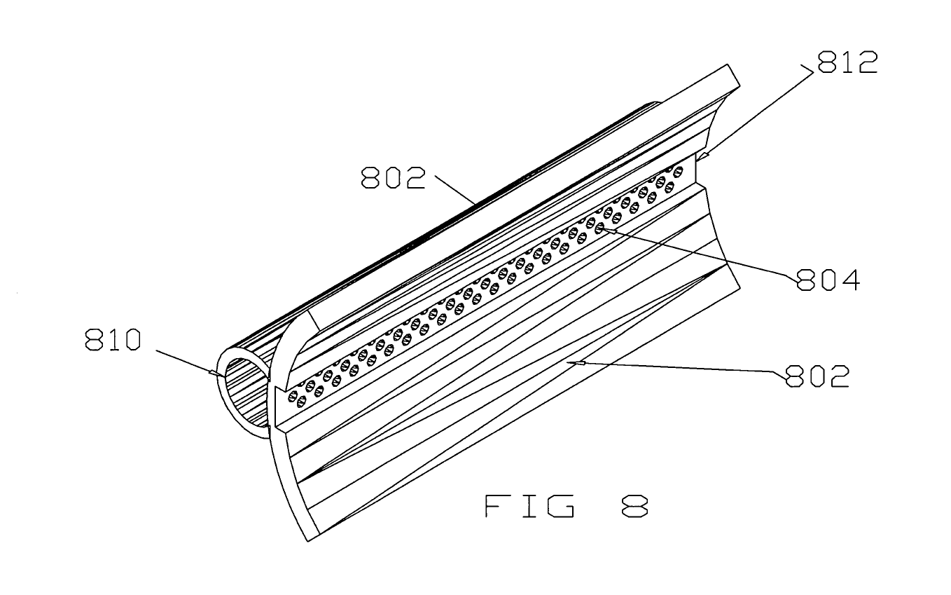

FIG. 9 shows a top view of the combination corona-flamer head 900 positioned relative to a mandrel and attached substrate or cup 902. In substantial proximity with the leading and trailing edges of the corona electrode 903 are orifices 904, 906 for producing air jets 908, 910 for constraining or focusing the corona ions 912 within a desired space. This embodiment has the advantage in that the orifices for producing the air jets have the advantage of not being integral to the combination head. This allows use of one or both of the air jets at the time the production machinery is configured (or reconfigured) and also allows for aiming and positioning of the air jet to accommodate various sizes of substrates or various applications of the ion treatment process. For example, both air jets are shown intersecting the substrate at a substantially tangential angle. In other applications the assembly supporting the orifices can be rotated to change the desired point of contact of the air jet with the substrate. The air jets may be used for cooling the substrate, enhancing the ion field, and/or constraining the ion field. Each orifice support assembly preferably has a chiller, such as a vortex, attached to it to further cool the air of the air jet prior to passing through the orifice and for cooling the air in close proximity with the orifice. The close proximity of the cooler and the orifice for the air jet is also advantageous in the aforementioned corona heads with integral air jet of FIG. 5, FIG. 5B, FIG. 6 and FIG. 7. Furthermore, the person setting up the production machinery may move orifices closer or farther from the substrate as desired. In this embodiment gas or other combustible substance flows down the center of the tube 920, which includes a diffuser, such as a wire mesh for diffusing the gas. The diffuser provides for more even flame distribution 922 within the flame slot 924. In alternate embodiments, the integral orifice of FIG. 5, FIG. 5B, FIG. 6 and FIG. 7 may be substituted for one or both of the separate orifice and air jet of FIG. 9.

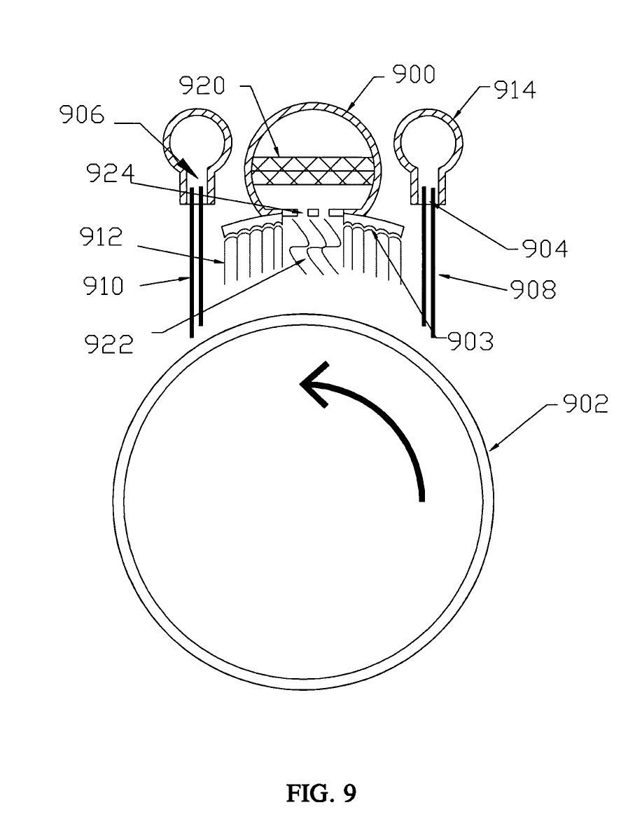

FIG. 10 shows a view looking head on at the corona electrode and flame slot and two orifices of FIG. 9, as would be seen from the perspective of the substrate being treated. The groves of the corona electrode and perforations of the flame slot are shown in detail.

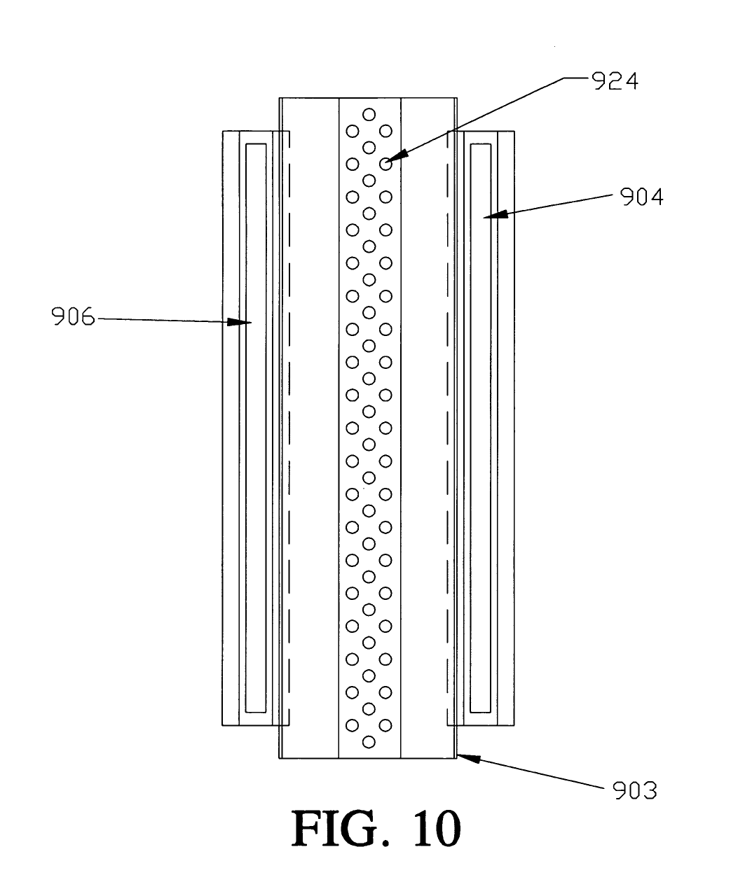

FIG. 11 and FIG. 12 show details of the flame head 1100 without a corona electrode. The center of the burner support tube 1102 has gas or other combustible substance which is diffused through a diffuser or wire mesh 1104 which provides for a more evenly distributed flame by the perforations in the burner head. In an alternate embodiment the burner head may be removable and the support assembly fitted with a combined corona flamer head. Thus, if the support assembly is electrified, the flame head may be converted into a combined corona-flame head. Furthermore, separate orifices and air jets may be mounted as shown in FIG. 9 and FIG. 10 allowing for the migration from a flame head to a combined corona-flamer head to a combined corona-flamer head with the aforementioned air jet advantages. This allows a production customer currently using flame ion treatment to install the flame head of FIG. 11 and FIG. 12 and then migrate to the improved corona-flame treatment with the installation of the corona-flame electrode. Then the customer may migrate to air jets provide by the separate orifice assemblies shown in FIG. 9 and FIG. 10.

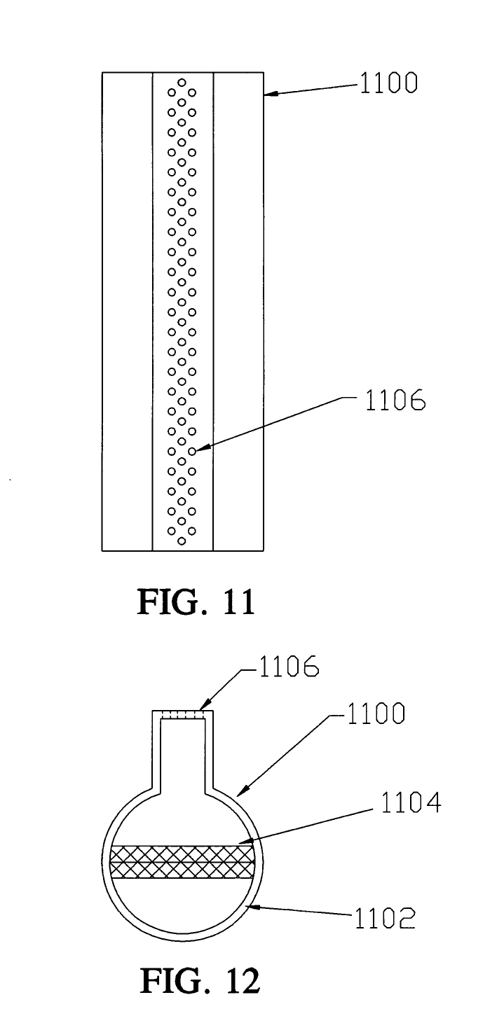

FIG. 13A shows a detail of the perforations used for the gas or other combustible substance for generating a flame. The top of the drawing sheet FIG. 13A is a cross section view 1302 taken along line X-X′ of top view 1304. Shown in the middle of this drawing sheet is a top view 1304 of the manifold/supply tube 1306 feeding the electrode 1314 with orifices 1312. To increase the surface area of the electrode 1314 a series of grooves 1310 are formed thereon. Lastly a side view 1316 is shown at the bottom of the sheet detailing the electrode 1314 being feed by manifold/supply tube 1306. The electrode in this embodiment is formed on an insulator 1308. The insulator may be fabricated from any electrical insulator material such as silicon.

FIG. 13B is an alternate embodiment of FIG. 13A with a leading edge 1420 on the electrode 1314. As discussed for FIG. 13A shown on the top of the drawing sheet is a cross section view 1402 taken along line Y-Y′ of top view 1404. Shown in the middle of this drawing sheet is a top view 1404 of the manifold/supply tube 1306 feeding the electrode 1314 with orifices 1312. To increase the surface area of the electrode 1314 a series of grooves 1310 are formed thereon. Lastly a side view 1416 is shown at the bottom of the drawing sheet detailing the electrode 1314 being feed by manifold/supply tube 1306. The electrode in this embodiment is formed on an insulator (not shown). A leading edge 1420. The use of the leading edge 1312 increases the surface area for treatment. The leading edge acts as a “primer” to the spark of the corona treatment during operation

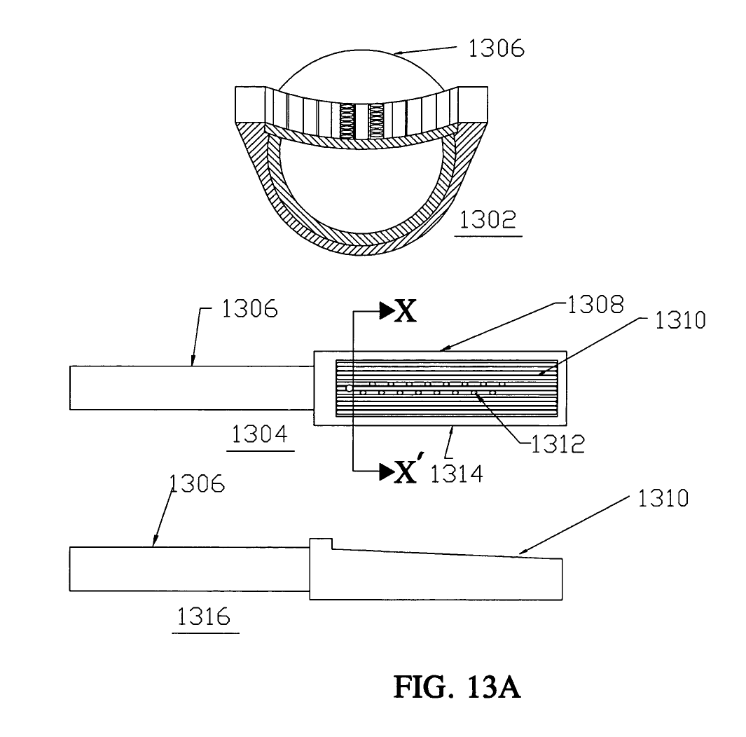

FIG. 14 shows a view of a dual head ion treatment at the PRETREAT station 1402 of the mandrel ring 1404. One head is a flame head 1406 and the other is a corona head 1408. The corona head has a chiller 1410 attached to the end opposite to the corona electrode end. The close proximity between the chiller and the orifice located close to the corona facilitates enhanced cooling of the air jet from the orifice. In the other embodiments the treating head can be a corona or corona-flamer head while the other head could be a flamer, corona-flame or corona head. As in FIG. 3 and FIG. 4, an air knife may be used to insulate the ion treatment heads. Note the close proximity between the print drum 1412 and the ion treatment head 1408.

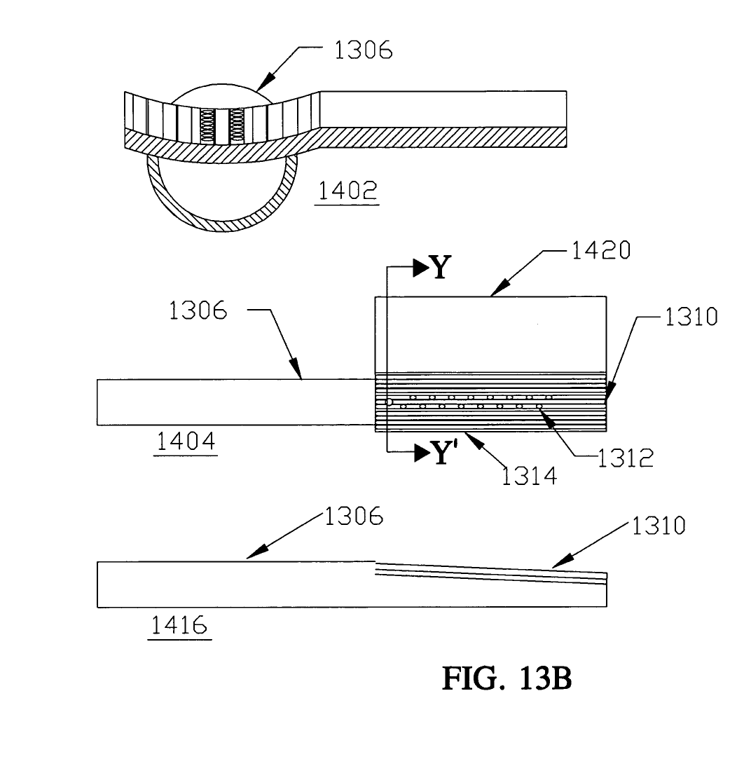

FIG. 15 shows a single ion treatment head at a single PRETREAT station 1502. The treatment head could be a corona or a corona-flamer head 1504. The close proximity between the chiller 1510 and the orifice located close to the corona facilitates enhanced cooling of the air jet from the orifice. Note the close proximity between the print drum 1512 and the ion treatment head.

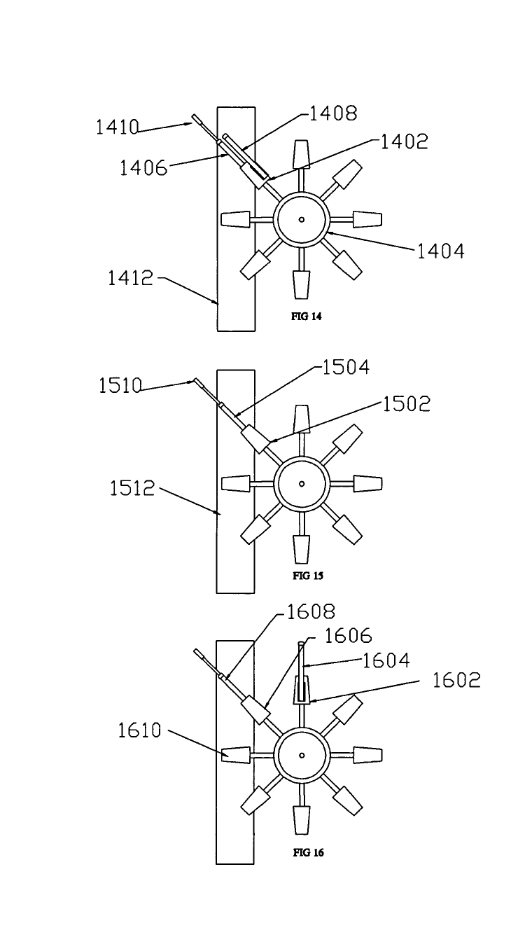

FIG. 16 shows dual position pretreatment. The PRETREAT 1 station 1602 may have a corona, flamer or corona-flamer ion treatment head 1604. The close proximity between the chiller and the orifice located close to the corona facilitates enhanced cooling of the air jet from the orifice. The PRETREAT 2 station 1606 has a flame head 1608 but in alternate embodiments may have a corona, flamer or corona-flamer ion treatment head. Preferably, the substrate is treated by both corona ions and flame ions prior to arriving at the PRINT station 1610.

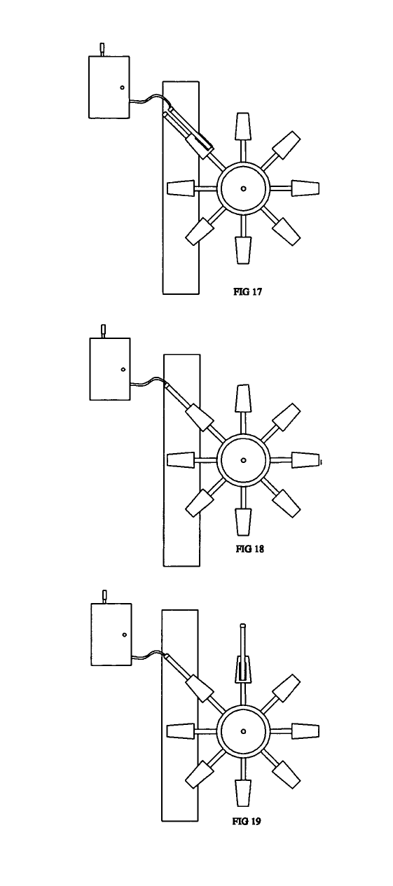

FIGS. 17-19 shows an alternate embodiment of a chiller control unit in a remote location.

While the process herein is described with respect to three-dimensional cylindrical substrates, such as plastic cups, the invention herein may be applied to a number of other substrate types including webs, credit cards, casings and other two and three-dimensional substrates. It should be appreciated that other modifications and alterations may be made to the description provided herein without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A process of enhancing surface bonding properties of a substrate comprising the steps of substantially simultaneously:
depositing combustion ions upon the substrate substantially immediately upon generation the combustion ions; and
depositing corona ions upon the substrate substantially immediately upon generation of the corona ions.

2. The process according to claim 1 wherein the combustion and corona ions are deposited in substantially sequential process steps.

3. The process according to claim 1 wherein the combustion ions are deposited in a substantially common process step.

4. The process according to claim 1 further comprising the steps of:
generating the combustion ions with a flame wherein said step depositing the combustion ions upon the substrate occurs substantially immediately thereafter; and
generating the corona ions with an electrical field wherein said step of depositing the corona ions upon the substrate occurs substantially immediately thereafter.

5. A process of enhancing surface bonding properties of a substrate comprising the steps of substantially simultaneously:
treating the substrate with combustion ions; and
treating the substrate with corona ions.

6. The process according to claim 5 further comprising the steps of:
generating the combustion ions with a flame wherein said step of treating the substrate with the combustion ions occurs substantially immediately thereafter; and
generating the corona ions with an electrical field wherein said step of treating the substrate with the corona ions occurs substantially immediately thereafter.

7. The process according to claim 5 wherein the substrate is treated with the combustion and corona ions in substantially sequential process steps.

8. The process according to claim 5 further comprising the steps of:
generating the combustion ions with a flame head assembly located at a first location wherein said step of treating the substrate with the combustion ions occurs substantially immediately thereafter; and
generating the corona ions with coronal head generating assembly located at a second position wherein said step of treating the substrate with the corona ions occurs substantially immediately thereafter.

9. The process according to claim 8 wherein the first and second locations are in close proximity and the process further comprises the step of
insulating the corona head from the flame head with an air knife.

10. The process according to claim 8 wherein the substrate is cylindrical and the process includes the step of
rotating the cylindrical substrate, and further wherein
the first location of the flame head is positioned opposite to the second location of the corona head relative to the rotating cylindrical substrate, and
the rotating cylindrical substrate is treated by the flame head with combustion ions at the first location while the substrate is further treated by the corona head with corona ions at the second location.

11. The process according to claim 10 further comprising the step of
cooling air; and
injecting the cooled air from the corona head into the corona ions thereby cooling the substrate.

12. The process according to claim 5 further comprising the step of
generating the combustion ions and the corona ions with a combination head for simultaneously generating a corresponding flame and corona in a substantially common location.

13. The process according to claim 12 farther comprising the steps of:
determining a presence of the corona;
providing a combustible gas for generation of the flame in response to said step of determining; and
igniting the combustible gas with the corona.

14. A combination flame and corona head for enhancing surface bonding properties of a substrate comprising:
a corona electrode for generating a corona by electrically charging an area between said electrode and a complementary electrode; and
at least one opening in the corona electrode for providing a combustible gas in the area of the corona,
said corona electrode facilitating generation of a corona and a flame within a common area.

15. The combination flame and corona head according to claim 14 wherein
the substrate is located between said corona electrode and the complementary electrode, and
the substrate is simultaneously treated with corona ions from the corona and combustion ions upon ignition of the combustible gas
thereby enhancing the surface bonding properties of the substrate.

16. The combination flame and coronal head according to claim 15 wherein
the complementary electrode is cylindrical,
the combination head generates the corona and flame in the common area corresponding to an arc portion of the cylindrical complementary electrode, and
said corona electrode has a curved surface corresponding to the arc portion of the cylindrical complementary electrode.

17. The combination flame and corona head according to claim 16 wherein the combination head is a component of a device for enhancing surface bonding properties of a plurality of cylindrical substrates and the device further comprises
a plurality of regularly spaced cylindrical complementary electrodes moving in a planar direction relative to said combination flame and corona head wherein each of the plurality of substrates is cylindrical and removably attaches to each of the plurality of corresponding complementary cylindrical electrodes; and
a controller for pausing the planar movement of each of the plurality cylindrical complementary electrodes at a predetermined position relative to said combination head thereby providing a predetermined gap of substantially constant distance between the curved electrode of the combination head and each cylindrical complementary electrode while paused in close proximity, while providing for the planar movement of the cylindrical complementary electrodes relative the combination head without movement of the combination head.

18. An enhanced head for generating a corona comprising:
a corona electrode for generating an ion field when electrified and placed in proximity with a complementary electrode, the ion field for treating the surface of a substrate located between the corona electrode and complementary electrode; and
an orifice for generating an air jet for constraining the location of the ion field.

19. The enhanced head according to claim 18 wherein
said corona electrode has two parallel sides; and
said orifice includes a first and second opening for generating first and second air jets in substantial proximity with the two parallel sides wherein the ion field substantially contained within the first and second air jets.

20. The enhance head according to claim 18 wherein
said corona electrode has a leading edge and a trailing edge,
the substrate moves through the generated ion field by entering at the leading edge and exiting at the trailing edge and
said orifice includes an opening for generating a trailing edge air jet in substantial proximity with trailing edge of said corona electrode wherein the ion field is substantially contained within the trailing edge of the air jet.

21. The enhanced head according to claim 20 further comprising
a flame orifice located in substantial proximity with the leading edge of said corona electrode for generating a flame for treating the surface of the substrate.

22. The enhanced head according to claim 20 wherein the ion field heats the substrate and the air jet further cools the substrate upon exiting the ion field.

23. The enhanced head according to claim 22 further comprising an air cooler connected to the enhanced head for the air cooling air prior to passing through the opening of said orifice.
